(19) United States
(12) Patent Application Publication
(10) Pub. No.: US 2017/0336006 A1
(43) Pub. Date: Nov. 23, 2017

(54) MALE COUPLING WITH INTEGRATED SHUNT SYSTEM, KIT COMPRISING SAID MALE COUPLING FOR ACHIEVING THE SHUNT FUNCTION ON THE MOVABLE SIDE OF A MULTI-COUPLING DEVICE AND MULTI-COUPLING DEVICE COMPRISING SAID KIT

(71) Applicant: Faster S.P.A., Rivolta D'Adda (IT)

(72) Inventors: Roberto Sorbi, Rivolta D'Adda (IT); Marco Neri, Rivolta D'Adda (IT); Paolo Rusconi, Rivolta D'Adda (IT)

(21) Appl. No.: 15/588,416

(22) Filed: May 5, 2017

(30) Foreign Application Priority Data
May 10, 2016 (EP) 16168922.9

(51) Int. Cl. F16L 37/56; F16L 37/413

(52) U.S. Cl. CPC F16L 37/56; F16L 37/413

(57) ABSTRACT

The present invention relates to a male coupling with integrated shunt system for the application on a multi-coupling device of the plate type, as well as a multi-coupling device comprising said coupling with integrated shunt system.

The invention thus makes it possible to implement the shunt function on movable plate side, i.e. on the plate configured to support a plurality of male couplings so as to short-circuit the male couplings when the plates are uncoupled.

The present invention further relates to a kit comprising at least one pair of male couplings with integrated shunt system and to a connection plate configured to achieve the fluid connection between the two male couplings, as well as a multi-coupling device comprising such a kit.

### CROSS REFERENCE TO RELATED APPLICATION(S)

The present application claims priority to European Patent Application No. 16168922.9 filed May 10, 2016, the entirety of the disclosures of which are expressly incorporated herein by reference.

### STATEMENT RE: FEDERALLY SPONSORED RESEARCH/DEVELOPMENT

Not Applicable.

### FIELD OF THE INVENTION

The present invention relates to a male coupling with integrated shunt system for the application on a multi-coupling plate device, as well as a multi-coupling device comprising said coupling with integrated shunt system.

The field of the invention is thus that of multi-coupling plate devices of the type which is the object of the previous patents owned by the same Applicant, which have become the benchmark for plate devices adapted to connect a plurality of hydraulic lines simultaneously.

The present invention relates to a further improvement of the prior art because, by virtue of the male coupling with integrated shunt system according to the present invention, it is possible to establish the connection between two hydraulic lines of the movable plate with the plates disconnected.

### PRIOR ART

The male coupling according to the present invention is specifically applied to multi-coupling devices of the plate type, made by the same Applicant and which have been known in the sector for several years also with the commercial name of “Multifaster”.

Said multi-coupling devices comprise a first plate, intended to be fixed on the machine side, and thus also named fixed plate, configured to support a plurality of female couplings, and a second plate intended to be connected to the user, and thus also named movable plate, configured to support a plurality of male couplings.

Typically, the movable plate is fastened onto the fixed plate by means of a cam and lever connection system, and the connection of the male couplings and the female couplings present on the respective plates occurs simultaneously.

In the multi-coupling devices of the type known in the prior art, a shunt system is provided in some cases exclusively between the female couplings of the fixed plate and thus devices and couplings capable of implementing the function that the following inventions aims to achieve are known in the prior art.

In the multi-coupling devices of known type of the prior art in which a shunt system is present on the fixed plate side, the fixed plate itself is exploited to convey the fluid from one female coupling to another, but it is not possible to have the shunt function actuated during the connection and/or disconnection maneuver on the movable plate side without the aid of valves or similar additional devices.

### SUMMARY

It is thus the task of the present invention to overcome the limits of the multi-coupling devices of known type by implementing the shunt function on movable plate side, i.e. on the plate configured to support a plurality of male couplings.

In the scope of such a task, it is the object of the present invention to provide a male coupling with an integrated shunt system for the movable plate side of a multi-coupling device which allows the communication of two lines on movable plate side also with male coupling disconnected from the female coupling.

It is another object of the present invention to provide a kit comprising a pair of said male couplings with integrated shunt system and a support plate configured to be connected to the movable plate of a multi-coupling plate device.

This task and these and other objects which will be clarified in greater detail hereinafter are achieved by a male coupling of the type comprising a main body having substantially cylindrical hollow conformation and longitudinal development, which encloses within the components of the coupling, such as an axial valve body axially movable with respect to said main body and an inner slider, also axially movable with respect to said main body. Said main body advantageously has a front end adapted to couple in a female coupling and a rear end to which a rear adapter is advantageously associated in stable manner.

The coupling is characterized in that said main body comprises at least one substantially radial hole for the fluid shunt and in that it comprises a lip seal interposed between said main body and said rear adapter and adapted to achieve the fluid sealing selectively against the outer surface of said inner cursor.

The presence of the lip seal is the element which allows the desired shunt function. More in particular, as can be seen in greater detail below, said seal provides its fluid sealing function only in given positions of the inner slider, allowing the passage of the fluid through said at least one radial hole with the coupling uncoupled.

### LIST OF FIGURES

Further features and advantages of the present invention will be more apparent from the following detailed description, provided by way of non-limiting example and illustrated in the accompanying figures, in which:

FIG. 1 shows a perspective partial section view of the male coupling with integrated shunt system according to the present invention;

FIG. 2 shows the kit according to the present invention comprising two male couplings with integrated shunt system in FIG. 1 and the connection plate, associated with the movable plate of a multi-coupling plate device and in a first step of connecting to corresponding female couplings accommodated in a fixed plate of said multi-coupling plate device. During this step, the shunt system present on the male couplings according to the present invention is open;

FIG. 3 shows the same components shown in FIG. 2 during a step of subsequent connecting of the couplings. Also during this step, the shunt system present on the male couplings according to the present invention is still open;

FIG. 4 shows the same components in FIG. 3 in a subsequent step of connecting of the couplings, in which the valves of the male couplings are still closed and the shunt system is still open;

FIG. 5 shows the same components as shown in FIG. 4 in a subsequent step of connecting of the couplings, in which the valves of the male couplings are open and the shunt system is closed. From this moment on, the couplings with integrated shunt system according to the present invention start working as standard male couplings;

FIG. 6 shows the path of the oil flow in the kit comprising two male couplings with integrated shunt system and the connection plate in the open shunt condition corresponding to the condition in which the plates of the multi-coupling device are disconnected.

### DETAILED DESCRIPTION OF THE INVENTION

The following description will illustrate a preferred embodiment of the male coupling with integrated shunt system according to the present invention, as well as an embodiment of the kit comprising two male couplings with integrated shunt system and a connection plate.

Such a description is provided by way of non-limiting example, thus all variants of what is described which may be considered equivalent are included in the scope of the present invention.

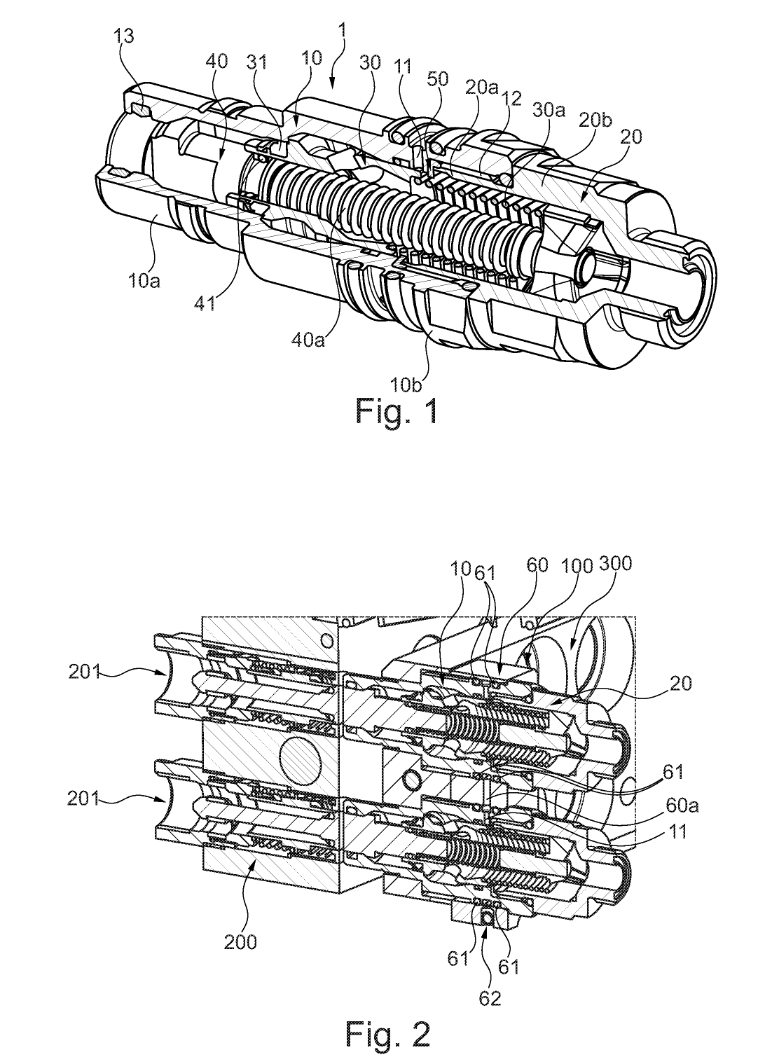

FIG. 1 shows a perspective partial section view of the male coupling 1 with integrated shunt system according to the present invention.

The male coupling 1 advantageously comprises at least a main body 10 and an adapter 20, both having substantially cylindrical hollow conformation and longitudinal development, which enclose the functional components of the coupling.

More in particular, said main body 10 will have a front end 10a adapted to couple in a female coupling and a rear end 10b to which a rear adapter 20 is advantageously associated in stable manner.

According to the preferred embodiment shown in the accompanying figures, the main body 10 is connected to said rear adapter 20 by means of a screw connection at said rear end 10b.

In FIG. 1, reference numeral 12 generically indicates the threaded connection between said main body 10 and said adapter 20.

Said main body 10 comprises at least one substantially radial through hole 11, which puts the part of the coupling 1 inside said main body 10 into connection with the outside for shunting the fluid.

Inside said main body 10 the coupling 1 further comprises a valve body 40. The inner surface of said main body 10 comprises a housing seat for an annular front seal 13, which comes into contact with the outer surface of said valve body 40 ensuring the fluid-tightness when the valve body 40 is in the closing condition.

Said valve body 40 is axially movable with respect to said main body 10, and its movement in longitudinal direction towards the rear part of the coupling 1 is contrasted by the first helical spring 40a which tends to take said valve body 40 to advanced position.

In turn, said valve body 40 is at least partially inserted in an inner slider 30, which also has a substantially cylindrical hollow conformation and which is axially sliding with respect to said main body 10. The movement of said inner slider 30 is contrasted by the action of the second helical spring 30a, the action of which tends to take said inner slider back to advanced position.

The words “advanced” and “retracted” are defined with reference to the “front” and “rear” part of the coupling: the front part is the one which connects to the female coupling, the rear part is the one connected to the hydraulic line. A position is “advanced” with respect to another when it is closer to the front part of the coupling.

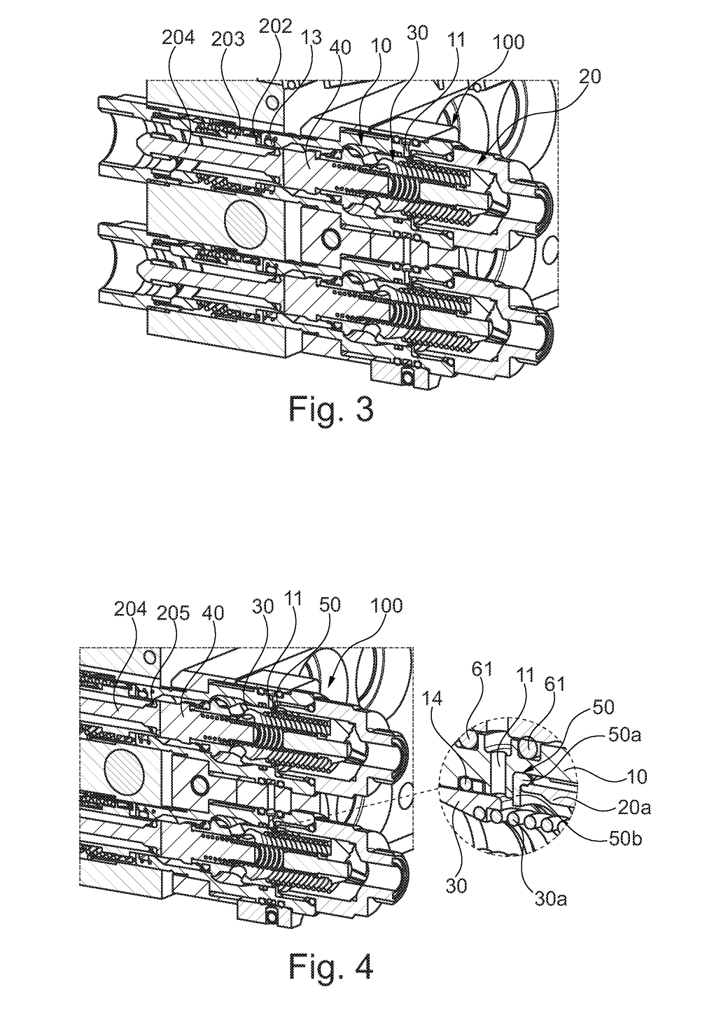

So, the valve body 40 is in advanced position when it is in the position shown in FIG. 2, and is in retracted position with respect to said main body 10 when it is in the position in FIG. 3.

Turning back to the description of the components of the male coupling 1 according to the present invention as shown in FIG. 1, said inner slider 30 supports a first seal 31 which ensures the sealing between the outer surface of said inner slider 30 and the inner surface of said main body 10.

A first sealing ring 41 ensures the fluid sealing between the outer surface of the valve body 40 and the inner surface of said inner slider 30.

The adapter 20 displays a front portion of the adapter 20a and a rear portion 20b. The front portion 20a of said adapter 20 has a smaller outer diameter than that of the rear portion 20b, and is inserted at least in part in the rear end 10b of said main body 10.

Between said front portion 20a of said adapter 20 and said rear portion 10b of said main body 10, a seal 50 is conveniently provided, preferably a lip seal, the section of which with a longitudinal plane has a profile comprising a first stretch 50a, which extends in substantially longitudinal direction towards the rear zone of the coupling, and a second stretch 50b, which extends in substantially radial direction towards the longitudinal axis of the coupling, the profile of the seal 50, preferably a lip seal, thus being “L”-shaped on a longitudinal plane.

Said lip seal 50 is in position closer to the rear part of the coupling with respect to the radial hole 11, while a sealing O-ring 14 is provided in position closer to the front part of the coupling with respect to the hole 11.

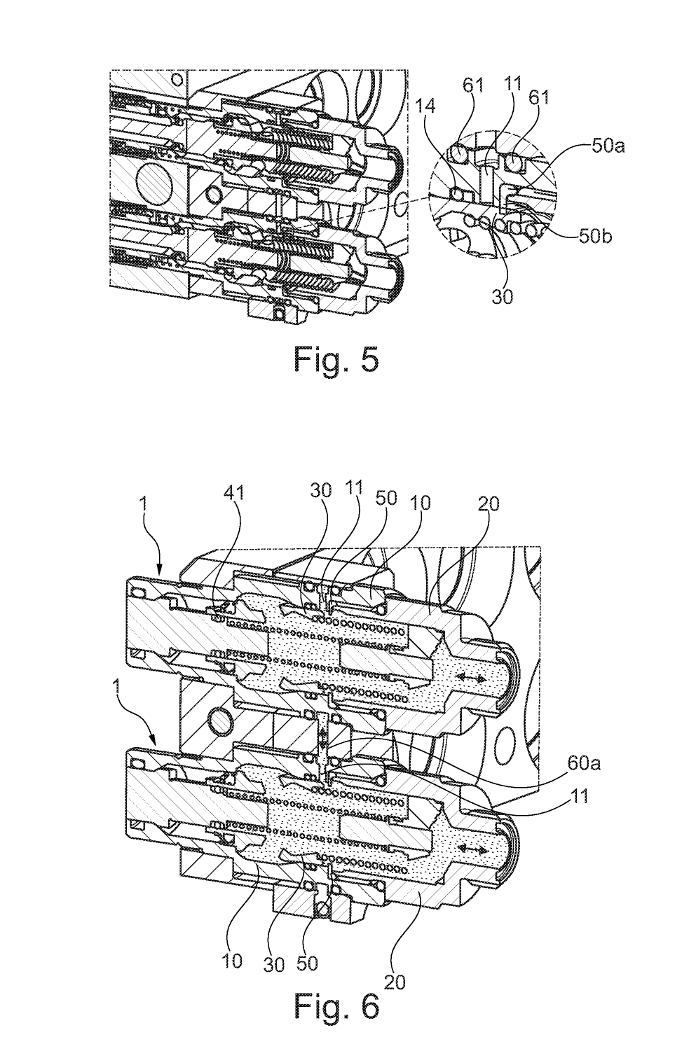

Said lip seal 50 has an annular development, as can be seen more clearly for example from the details in FIGS. 4 and 5.

The second stretch 50b of said lip seal 50 is thus configured so as to come selectively into contact with the outer surface of said inner slider 30, thus allowing the oil to flow out through said at least one radial hole 11 provided on said main body 10.

Thus, having described the main components of the male coupling 1 with integrated shunt system according to the present invention, the additional component which forms the kit 100 according to the present invention will now be described.

Said kit 100 comprises a first and a second male coupling 1 with integrated shunt system according to what has been described hereto, and a connection plate 60 configured to establish the hydraulic connection between said two male couplings 1. Said connection plate 60 being associable to the movable plate of a multi-coupling plate connector.

Said connection plate 60 comprises two seats for inserting an equal number of male couplings 1 with integrated shunt system according to the present invention.

More in detail, for example with reference to FIGS. 2 and 3, said connection plate 60 comprises, in turn, at least one shunt conduit 60a, which is configured to convey the oil coming from the radial hole 11 of the first male coupling 1 towards the second male coupling 1.

The path of the fluid during the various steps of connecting of the male couplings 1 will be described in greater detail below, while here it is important to describe that the outward sealing is ensured by sealing elements 61, preferably consisting of O-rings made of polyurethane, and a plug 62, e.g. of the Koenig-expander type.

The operation of the male couplings 1 and of the kit 100 according to the present invention will now be described in association with a multi-coupling device of the plate type.

With particular reference to FIG. 2, the kit 100 comprises two male couplings 1 with integrated shunt system and a connection plate 60 in which said couplings 1 are inserted. FIG. 2 shows the fixed plate 200 on which female couplings 201 are installed, and the movable plate 300 on which the kit 100 is installed. FIG. 2 shows the first step of coupling, in which the movable plate 300 is approached to the fixed plate 200 until contact is established between the front part of the male 1 and female 201 couplings.

During this step, as can be seen, the shunt is open: the lip seal 50 does not seal against the inner slider 30 which is, in the resting condition corresponding to the position in which the coupling is uncoupled, held in its advanced position by the bias of the second helical spring 30a.

With reference to FIG. 3, continuing in the coupling between the main body 10 of the male coupling 1 makes the outer slider 202 of the female coupling 201 retract and forms a seal with the face seal 13 in connection with the inner slider 203 of the female coupling.

Continuing further in the coupling operation, the reference being now to FIG. 4, the male coupling 1 continues the travel opening the passage of the female coupling, because the valve body 204 with the seal 205 stops forming a seal on the inner surface of the inner slider 203.

However, the valve of the male coupling 1 is still closed because the first seal 31 ensures the sealing between the outer surface of said inner slider 30 and the inner surface of said main body 10.

However, the valve body 40 has now reached end of travel and starts pushing the inner slider 30 backwards, too.

During this step, the shunt system is still open, as can be seen in the enlargement in FIG. 4, in which it is noted that the lip seal 50 no longer connects to the slider 30, but is close to closing, which occurs after the opening of the valve of the male coupling.

Indeed, in FIG. 5 it is noted that the passage of oil between the couplings is allowed by the opening also of the valve of the male coupling: by retracting, the valve body 40 of the male coupling pushes the inner slider 30 making it retract and allowing the sealing of the lip seal 50 on the outer surface of the inner slider 30, thus closing the shunt system, as shown in the enlargement in FIG. 5.

The male couplings 1 during this step are connected to the female couplings and work as standard male couplings.

The operation of the connection plate 60 of the shunt kit 100 will now be described with reference to FIG. 6.

When the plates of the multi-coupling device are disconnected, the male couplings 1 are in the condition shown in FIGS. 2 and 6. The shunt system on both male couplings 1 is open, and indeed it is noted that the inner slider 30 is in advanced position and that the lip seal 50 does not seal against the outer surface of the inner slider 30.

The working fluid, typically pressurized oil, arriving from one of the two hydraulic lines connected to the user and to the adapter 20 of a male coupling, fills the coupling, is sealed in front by the seal 31 which ensures the sealing between the outer surface of said inner slider 30 and the inner surface of said main body 10, and may solely flow through the radial hole 11 towards the adjacent male coupling 1 through the shunt conduit 60a, which is configured so as to connect hydraulically the two male couplings 1 and thus to implement the shunt function.

According to the preferred embodiment of the male coupling 1 with the integrated shunt system according to the present invention, the lip seal 50 is held in position by virtue of the shape of the seat formed by grooves respectively present on said main body 10 and on said adapter 20.

The sealing that the lip seal 50 performs on the outer surface of said inner slider 30 allows the shunt function, as seen: when the inner slider 30 is in advanced position the shunt is open and the oil may be short-circuited between the two male couplings 1, when either one or both the male couplings are connected to the corresponding female coupling the inner slider 30 is pushed into retraced position, thus closing the shunt.

Of course, the closing of the shunt would not be ensured unless a further O-ring 14 were advantageously provided, with respect to the hole 11 in position closer to the front part of the coupling, to provide the fluid-tightness between said inner slider 30 and said main body 10 thus ensuring that the fluid cannot reach the radial hole 11.

We have thus shown how the present invention achieves the set task and objects. All variants of the present invention which differ from the embodiment shown here by way of example only and comprised in the scope of the appended claims are intended to be part the invention in all cases.

1. A male coupling comprising at least a main body and an adapter both having substantially cylindrical hollow conformation and longitudinal development, wherein said main body comprises a front end, adapted to engage with a female coupling, and a rear end, to which said rear adapter is stably associated, said coupling further comprising, inside said main body and axially sliding with respect thereto, at least one valve body and at least one inner slider, characterized in that it further comprises at least one radial through hole in said main body, which hole puts the inner part of the coupling into connection with the outside for shunting the fluid, and in that it comprises, on the inner surface of said main body and next to said radial hole, at least one seal configured to achieve selectively the fluid-tightness in connection with the outer surface of said inner slider.

2. The male coupling according to the preceding claim, wherein said seal is a lip seal having an “L”-profile along a longitudinal section plane.

3. The male coupling according to the preceding claim, wherein said lip seal comprises a first stretch, which extends in substantially longitudinal direction towards the rear zone of the coupling, and a second stretch, which extends in substantially radial direction towards the longitudinal axis of the coupling, said second stretch of said lip seal being configured so as to come selectively into contact with the outer surface of said inner slider, thus closing the passage of oil towards said at least one radial hole provided in said main body.

4. The male coupling according to claim 1, wherein said adapter has a front portion of the adapter and a rear portion of the adapter, said front portion of said adapter having a smaller outer diameter than that of the rear portion and being inserted at least in part in the rear end of said main body.

5. The male coupling according to claim 1, wherein said seal is accommodated in a seat formed by grooves present on said main body and on said adapter, at the interface between said elements, respectively.

6. The male coupling according to claim 1, wherein said main body comprises a face seal inserted in a housing seat obtained on said main body.

7. The male coupling according to claim 1, wherein said valve body is at least partially inserted within said inner slider, which is axially movable with respect to said main body, in turn.

8. The male coupling according to claim 1, wherein it further comprises at least one O-ring interposed between said inner slider and said main body adapted to achieve the fluid-tightness.

9. A kit for shunting hydraulic lines in multi-coupling plate devices, comprising a least one first and one second male coupling according to any one of the claims from 1 to 8, and at least one connection plate comprising at least two seats for inserting said first and second male couplings, and further comprising at least one shunt conduit configured to create a fluid connection between the first and the second male coupling, conveying the oil coming from the radial hole of a coupling towards the radial hole of the other coupling.

10. A multi-coupling device comprising a kit for shunting hydraulic lines according to claim 9.
